(19) United States
(12) Patent Application Publication
(10) Pub. No.: US 2016/0214861 A1
(43) Pub. Date: Jul. 28, 2016

(54) METHOD AND APPARATUS FOR PRODUCING HYDROCHLORIC ACID

(71) Applicant: Shin-Etsu Chemical Co., Ltd., Tokyo (JP)

(72) Inventors: Masami TERASHIMA, Ibaraki (JP); Takaaki NAGAO, Ibaraki (JP); Katsumi MIYOSHI, Ibaraki (JP)

(21) Appl. No.: 15/007,202

(22) Filed: Jan. 26, 2016

(30) Foreign Application Priority Data
Jan. 28, 2015 (JP) 2015-013858

(51) Int. Cl. C01B 7/07; B01D 53/14; B01D 53/18

(52) U.S. Cl. CPC C01B 7/0718; B01D 53/18; B01D 53/1456; B01D 2252/103

(57) ABSTRACT

Hydrochloric acid is produced by capturing hydrogen chloride contained in an exhaust gas resulting from a gas-phase chemical reaction process involving a dehydrochlorination reaction, the hydrochloric acid is guided into one or some refinery columns of a plurality of refinery columns arranged in parallel so that iron ions are removed from the hydrochloric acid, in accordance with deterioration of iron ion removal capability in the one or some refinery columns, the removal of the iron ions from the hydrochloric acid is switched to another one or some of the refinery columns, while the hydrochloric acid is guided into the other one or some refinery columns so that the iron ions are removed from the hydrochloric acid, the deteriorated iron ion removal capability is regenerated.

The contents of the following Japanese patent application are incorporated herein by reference:

No. 2015-013858 filed on Jan. 28, 2015.

### BACKGROUND

1. Technical Field

The present invention relates to a method and an apparatus for producing hydrochloric acid from hydrogen chloride contained in the exhaust gas resulting from a gas-phase chemical reaction process of SiCl₄ or the like that involves a dehydrochlorination reaction.

2. Related Art

In order to produce synthetic quartz for optical fiber base materials and the like, a method is known to produce silica fine particles by a flame hydrolysis reaction of a source material such as SiCl₄ in an oxyhydrogen flame. According to this producing method, the exhaust gas contains an enormous amount of silica fine particles that fail to be deposited to form the base materials and a considerable amount of hydrogen chloride gas produced by the dehydrochlorination reaction during the hydrolysis reaction. In order to remove the silica fine particles that fail to be deposited and the hydrogen chloride gas from the system, a gas filtering device such as a bag filter is used to collect the silica fine particles, and the hydrogen chloride gas is guided into a reaction tank of a wash column, into which water is sprayed to allow the hydrogen chloride to be absorbed by the water and thus to be collected as hydrochloric acid. The collected silica fine particles are reused as silica fine powders.

Here, the collected hydrochloric acid contains super-fine silica particles that have passed through the gas filtering device and iron originating from the materials of the exhaust gas flues and the like accompanying the production equipment. Among these, the super-fine silica particles can be physically removed using dense liquid-phase filters and the like. However, physical approaches such as use of filters and the like cannot easily remove the iron since the iron is dissolved in the hydrochloric acid and exists as iron ions. For this reason, it is difficult to industrially make a profit by reusing the collected hydrochloric acid as reagents. Accordingly, it is generally done to neutralize the collected hydrochloric acid using caustic soda or the like and then dispose of the result as waste. Alternatively, the collected hydrochloric acid has been reused only under the circumstances where hydrochloric acid of low purity containing dissolved iron ions is allowable.

In light of the above-described drawbacks, the objective of the present invention is to provide a method and an apparatus for producing hydrochloric acid that can continuously and stably remove iron ions contained in high concentration in the hydrochloric acid that is extracted from the exhaust gas resulting from a gas-phase chemical reaction process involving a dehydrochlorination reaction (hereinafter, simply referred to as “process exhaust gas”).

### SUMMARY

An aspect of the innovations may include a method for producing hydrochloric acid, where hydrochloric acid is produced by capturing hydrogen chloride contained in an exhaust gas resulting from a gas-phase chemical reaction process involving a dehydrochlorination reaction, the hydrochloric acid is guided into one or some refinery columns of a plurality of refinery columns arranged in parallel so that iron ions are removed from the hydrochloric acid, in accordance with deterioration of iron ion removal capability in the one or some refinery columns, the removal of the iron ions from the hydrochloric acid is switched to another one or some of the plurality of refinery columns, while the hydrochloric acid is guided into the other one or some refinery columns so that the iron ions are removed from the hydrochloric acid, the deteriorated iron ion removal capability is regenerated, and treatment of the hydrochloric acid and the regeneration of the iron ion removal capability are sequentially switched among the plurality of refinery columns arranged in parallel so that the production of the hydrochloric acid from the exhaust gas and the iron ion removal from the produced hydrochloric acid are continuously performed.

Another aspect of the innovations may include an apparatus for producing hydrochloric acid, including a reaction tank for producing hydrochloric acid from hydrogen chloride contained in an exhaust gas resulting from a gas-phase chemical reaction process involving a dehydrochlorination reaction by spraying water to allow the hydrogen chloride to be absorbed by the sprayed water, a plurality of refinery columns arranged in parallel, the plurality of refinery columns being configured to use ion-exchange resins to capture and remove iron ions contained in the hydrochloric acid, and a hydrochloric acid supply line and a pure water supply line to each of the plurality of refinery columns. Here, supplying and suspending the supply of the hydrochloric acid and pure water are sequentially switched among the plurality of refinery columns so that the iron ion removal realized by the ion-exchange resins in one or some of the refinery columns with which the hydrochloric acid is supplied and regeneration of iron ion removal capability of the ion-exchange resins realized by the pure water in another one or some of the refinery columns with which the pure water is supplied are performed in parallel.

### BRIEF DESCRIPTION OF THE DRAWINGS

FIG. 1 is a schematic view illustrating iron ion removal equipment designed to remove iron ions from hydrochloric acid in accordance with an embodiment of the present invention.

FIG. 2 shows the relation between the SV value and the iron ion concentration.

FIG. 3 shows the relation between the amount of treated hydrochloric acid and the iron ion concentration.

FIG. 4 shows the relation between the amount of supplied pure water and the concentration of the iron ions dissolved into the pure water to determine the conditions under which ion-exchange resins are to be regenerated.

FIG. 5 shows the transition of the concentration of the iron ions remaining in the hydrochloric acid observed in a case of continuous operation using four systems.

### DESCRIPTION OF EXEMPLARY EMBODIMENTS

The iron ions contained in the hydrochloric acid extracted from the process exhaust gas can be selectively and efficiently captured by means of strongly basic anion-exchange resins. The iron ions contained in the hydrochloric acid can be removed by continuously supplying the hydrochloric acid to the container filled with the above-mentioned ion-exchange resins in order to allow the hydrochloric acid to pass through the ion-exchange resins. Here, the iron ion capture capability of the ion-exchange resins deteriorates once the amount of the treated hydrochloric acid exceeds a predetermined amount. To address this issue, a plurality of containers each of which is filled with similar ion-exchange resins are provided in parallel. At the time when the iron ion capture capability of the ion-exchange resins in one of the containers deteriorates, the treatment of the hydrochloric acid is switched to another one of the containers filled with the ion-exchange resins and the ion-exchange resins are regenerated in the first container. In other words, the treatment of the hydrochloric acid is switched between the containers at the time when the iron ion capture capability of the ion-exchange resins deteriorates so that the treatment of the hydrochloric acid and the regeneration of the ion-exchange resins are sequentially performed among the containers provided in parallel. In this manner, the iron ions can be continuously removed from the hydrochloric acid without interrupting the refinement of the hydrochloric acid for the regeneration of the ion-exchange resins.

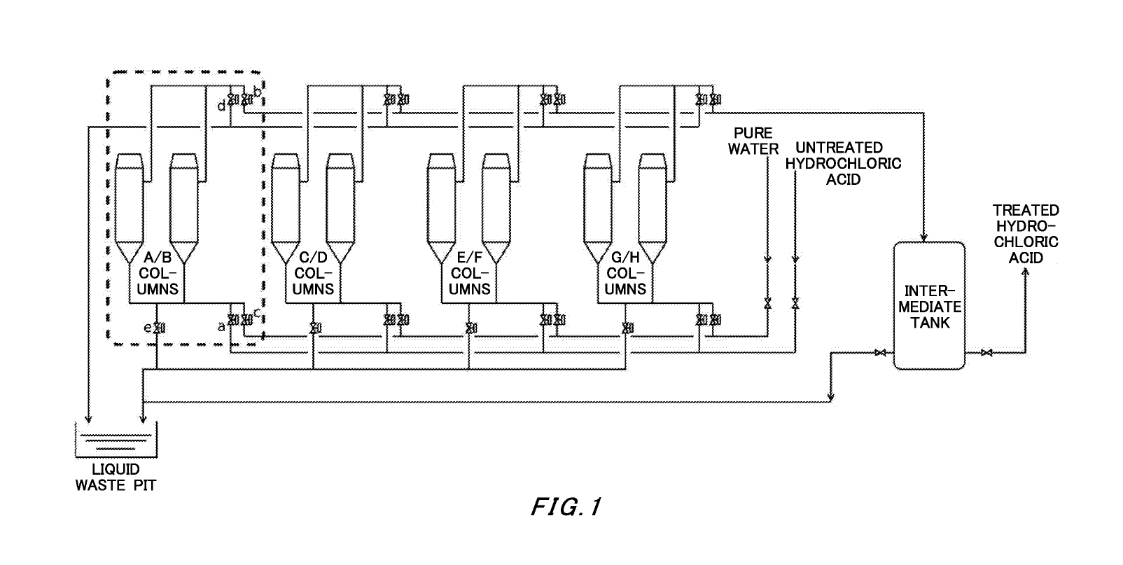

FIG. 1 is a schematic view illustrating an apparatus for producing highly pure hydrochloric acid in accordance with the present embodiment. As shown in FIG. 1, a four-system apparatus for producing highly pure hydrochloric acid is provided, where one system includes a pair of two refinery columns designed for removing iron ions from the hydrochloric acid extracted from the process exhaust gas. Note that the present invention is not limited by the number of the refinery columns in one system and the number of the systems and that a variety of combinations can be contemplated and appropriately selected taking into consideration such parameters as the amount of the hydrochloric acid to be treated and the concentration of the iron ions.

The refinery columns designed to remove the iron ions have an inner diameter of approximately 0.6 m and made of a acid-resistance material. For example, the refinery columns are cylindrically shaped and made of vinyl chloride resins. Each of the refinery columns is filled with 400 liters of strongly basic anion-exchange resins in the form of chloro complexes that can selectively capture the iron ions. At the top and bottom of the straight body portions in which the ion-exchange resins are provided, filters in the form of perforated plates are attached in order to prevent the ion-exchange resins from flowing out of the systems. The ion-exchange resins are poured up to the height of approximately 1.5 m. Two such columns are combined to form one system. The amount of the ion-exchange resins per system reaches 800 liters.

A hydrolysis reaction of SiCl₄ in an oxyhydrogen flame produces silica and, at the same time, causes a dehydrochlorination reaction, which produces hydrogen chloride. The hydrogen chloride in the exhaust gas is captured to produce hydrochloric acid. Specifically, water is sprayed into a reaction tank to allow the sprayed water to absorb the hydrogen chloride. In the present example, the process exhaust gas contains hydrogen chloride gas of approximately several thousand ppm (volume). The process exhaust gas is guided through a gas filter to remove the contained silica fine powders before introduced into a gas wash column to be washed with water. As a result, a hydrochloric acid solution of 14% is collected. Additionally, the collected solution is guided through a filter to remove superfine silica fine particles before supplied, as untreated hydrochloric acid of low purity, to one of the systems constituting the iron ion removal equipment, i.e., refinery columns A/B. By opening valves a and b of the hydrochloric acid supply line, the hydrochloric acid of low purity is guided through the valve a into the refinery columns A/B from the bottoms of the columns and treated through the ion-exchange resin layers in the columns. In other words, the iron ions in the hydrochloric acid are removed by allowing the iron ions to come into contact with the ion-exchange resins enclosed in the refinery column so that the ion-exchange resins can capture the iron ions. The ion-exchange resins are strongly basic anion-exchange resins in the form of chloro complexes that can selectively capture iron ions, and capable of restoring the iron ion removal capability by removing the captured iron ions. The treated hydrochloric acid flows out of the tops of the refinery columns A/B, passes through the valve b and flows toward an intermediate tank. The flow rate of the hydrochloric acid treated in the refinery columns A/B can be adjusted by controlling the ratios of the opening of the valves a and b.

Here, the amount of fluid to be treated per unit amount of ion-exchange resin is referred to as the SV value, which is defined by Expression 1 as follows.

$$SV VALUE = \frac{ \begin{matrix}FLOW RATE OF LIQUID TO \\ BE TREATED ( LITERS \text{/} HOUR )\end{matrix}}{\begin{matrix}AMOUNT OF ION - \\ EXCHANGE RESINS ( LITERS )\end{matrix}} \qquad Expression 1$$

The SV value is varied by varying the flow rate of the hydrochloric acid of low purity to be treated, which is accomplished by regulating the valves. For each level of the SV value, the hydrochloric acid of low purity is continuously supplied and treated, and the concentration of the iron ions in the hydrochloric acid before and after the treatment is analyzed using the ICP emission spectrography.

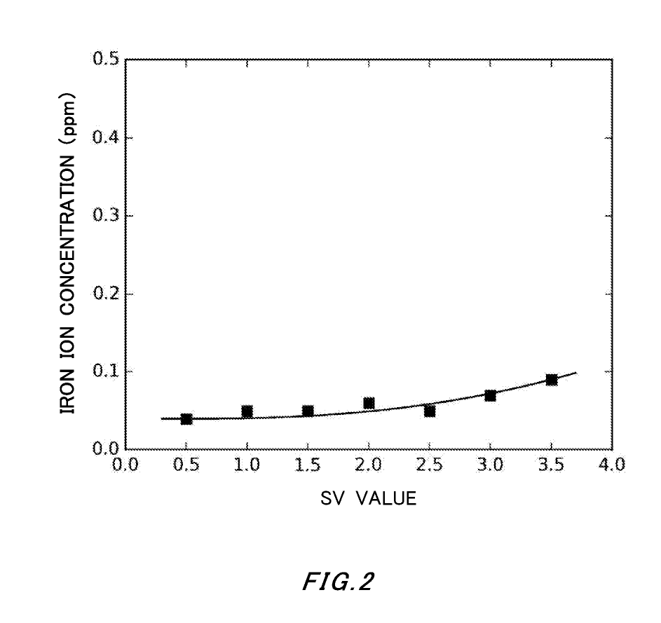

The iron ion concentration of the hydrochloric acid of low purity fall within the range of no less than 1.2 ppm (weight) and no more than 1.5 ppm (weight) through the sequential treatments. The relation between the SV value and the iron ion concentration in the treated hydrochloric acid is shown in FIG. 2. When the SV value is 3.5 or less, the iron ion concentration in the treated hydrochloric acid is stably 0.1 ppm (weight) or less, which indicates that the treatments have removed a sufficient amount of iron ions. In particular, when the SV value is 3 or less, the removal is reliably achieved.

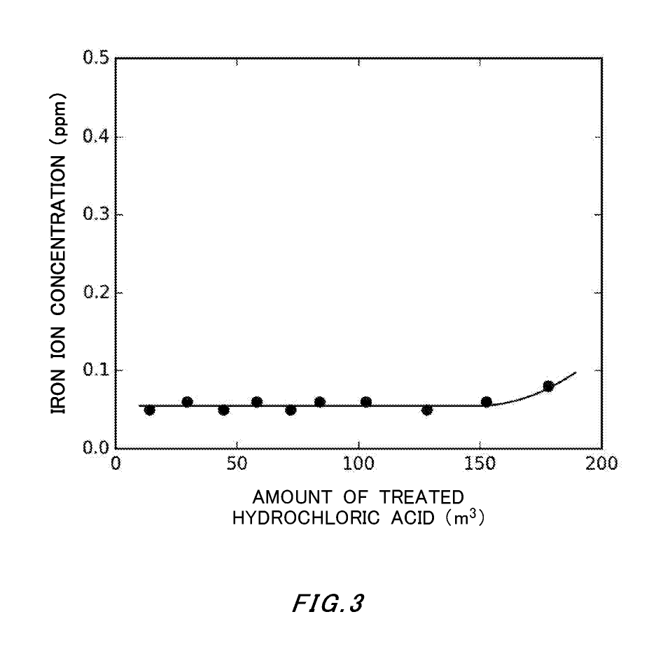

Next, the flow rate is fixed to achieve an SV value of 2.25, the hydrochloric acid of low purity is continuously supplied to one system, and the iron ion concentration in the treated hydrochloric acid is measured. The relation between the total amount of the treated hydrochloric acid and the iron ion concentration in the treated hydrochloric acid is shown in FIG. 3. When the amount of the treated hydrochloric acid reaches 152 m³ or so, that is to say, 190-fold of the volume of the ion-exchange resins, the amount of the iron ions remaining in the hydrochloric acid starts to rise, which indicates the effects of removing the iron ions have weakened. Thus, at the time when the total amount of the treated hydrochloric acid reaches 180 m³, the treatment of removing the iron ions in the hydrochloric acid is interrupted and the ion-exchange resins are regenerated using pure water.

The ion-exchange resins are regenerated in the following manner. To begin with, the valves a and b of the hydrochloric acid supply line are closed to suspend the hydrochloric acid of low purity from flowing into and out of the refinery columns A/B. Then, the valve e is opened to discharge the not-yet-treated hydrochloric acid remaining in the columns through the lower pipe into a liquid waste pit. After the remaining hydrochloric acid has been discharged from the refinery columns A/B, the valve e is closed and the valve c of the pure water supply line is opened to supply the columns with pure water. At the time when the resins have been entirely and sufficiently immersed into the pure water, the supply of the pure water is interrupted (the valve c is closed) and this state is kept for several minutes. Subsequently, the valve e is opened again to discharge the liquid in the columns through the lower pipe into the liquid waste pit. After this, the valve e is closed, the valves c and d of the pure water supply line are opened to continuously supply pure water with the refinery columns through the bottoms thereof at the rate of 1500 liters/hour (25 liters/minutes) for the purpose of washing the refinery columns with the free flow of the pure water.

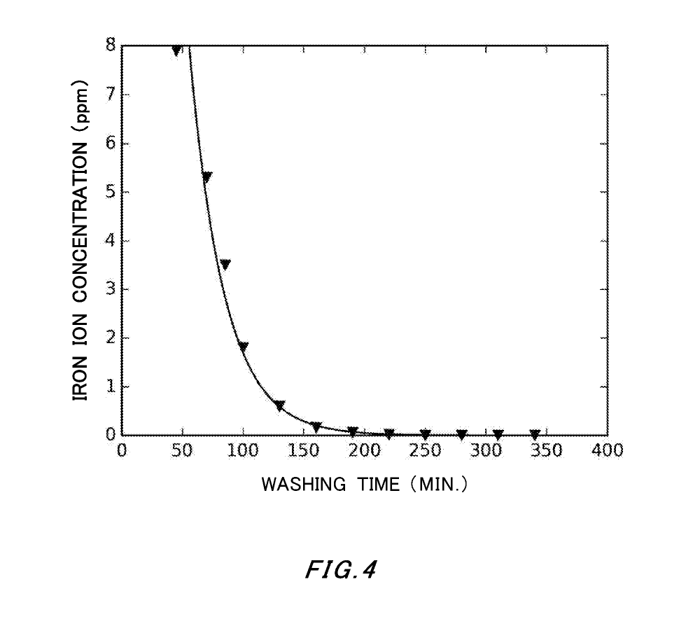

The pure water (regeneration water) that has passed through the refinery columns is discharged through the valve d into the liquid waste pit. The relation between the concentration of the iron ions in the discharged regeneration water and the washing time is shown in FIG. 4. Note that the iron ion concentration is analyzed using the ICP emission spectrography. When approximately 200 minutes has elapsed after the start of the continuous supply of the pure water, the iron ions, which dissolve from the resins, are no longer found in the regeneration water. After this, the valves c and d are closed and the valve e is opened to discharge the regeneration water remaining in the columns into the liquid waste pit. Subsequently, the valve e is closed. In this manner, the regeneration of the resins is completed.

The ion-exchange resins in the plurality of refinery columns are sequentially regenerated at predetermined cycles and reused for the iron ion removal process. In this manner, the iron ions contained in the hydrochloric acid may be continuously removed.

As described above, a method and an apparatus for producing hydrochloric acid of high purity are provided that produce hydrochloric acid from the hydrogen chloride contained in the exhaust gas resulting from a gas-phase chemical reaction process involving a dehydrochlorination reaction, and refine and improve the quality of the hydrochloric acid to reuse the resulting hydrochloric acid as a valuable. Accordingly, the embodiments of the present invention uses the iron ion removal equipment to refine even colored hydrochloric acid in which iron compounds are dissolved in high concentration and thus continuously and reliably treat the hydrochloric acid. As a consequence, the embodiments of the present invention can provide hydrochloric acid of high purity and quality that can be used as a reagent.

### Implemented Examples

The apparatus shown in FIG. 1, where four systems of refinery columns are arranged in parallel and each system includes two columns, was used. The process to remove the iron ions from the hydrochloric acid of low purity that was extracted from the process exhaust gas was performed continuously with the ion-exchange resin regeneration process being performed during the continuous iron ion removal process.

While three out of the four systems of refinery columns were supplied in parallel with the hydrochloric acid of low purity to perform the iron ion removal process, the remaining one system performed the resin regeneration process.

The resin regeneration process involved a series of steps including: a. discharging the remaining hydrochloric acid; b. introducing/discharging the pure water; and c. continuously supplying the pure water to provide free flows of the pure water (200 minutes)/discharging the pure water. On the completion of the resin regeneration process of one of the systems, this system was supplied with the hydrochloric acid of low purity to start the iron ion removal process and the next one system suspended the iron ion removal process and started the resin regeneration process. In this manner, the iron ion removal process and the resin regeneration process went around the four systems in the order of the A/B columns, the C/D columns, the E/F columns and the G/H columns, . . . within approximately 24 hours.

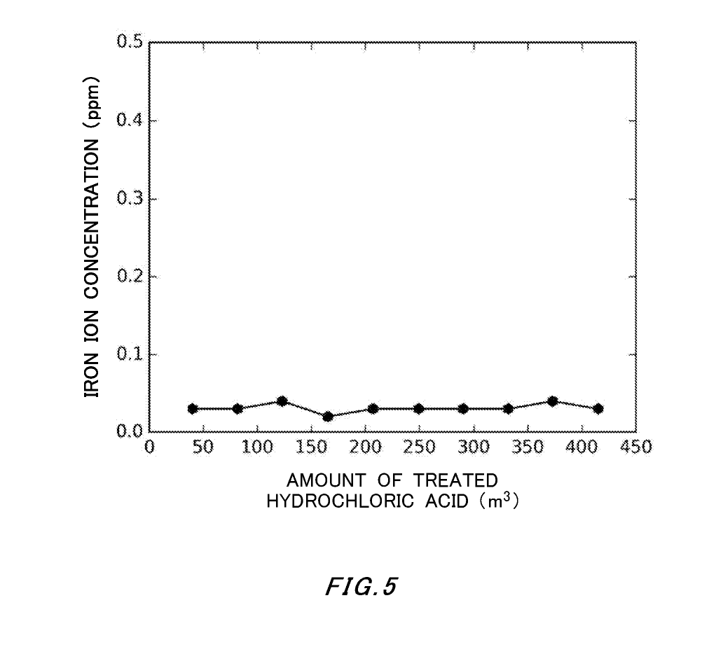

The hydrochloric acid to be treated was supplied at the flow rate of 3000 liters/hour, and the SV value was set to 1.25 while three systems were simultaneously operated. Under these conditions, the systems were continuously operated and the transition of the concentration of the iron ions in the treated hydrochloric acid was measured. The results are shown in FIG. 5, which indicates that the iron ion concentration was kept to be no less than 0.02 ppm (weight) and no more than 0.04 ppm (weight) and hydrochloric acid of high quality was thus reliably provided.

Note that the hydrochloric acid of low purity had a concentration of approximately 14% and an iron ion concentration of no less than 1.2 ppm (weight) and no more than 1.5 ppm (weight). The iron ion concentration was analyzed using the ICP emission spectrography.

As described above, the iron ion removal process and the resin regeneration process were cyclically repeated while the processes were sequentially switched among the plurality of refinery columns arranged in parallel (i.e., ion-exchange-resin-filled columns). As a consequence, the hydrochloric acid collection equipment itself can continuously obtain, from the hydrochloric acid of low purity, hydrochloric acid that can be reused as high-valued hydrochloric acid having reliable quality.

What is claimed is:

1. A method for producing hydrochloric acid, wherein
hydrochloric acid is produced by capturing hydrogen chloride contained in an exhaust gas resulting from a gas-phase chemical reaction process involving a dehydrochlorination reaction,
the hydrochloric acid is guided into one or some of a plurality of refinery columns arranged in parallel so that iron ions are removed from the hydrochloric acid,
in accordance with deterioration of iron ion removal capability in the one or some refinery columns, the removal of the iron ions from the hydrochloric acid is switched to another one or some of the plurality of refinery columns,
while the hydrochloric acid is guided into the other one or some refinery columns so that the iron ions are removed from the hydrochloric acid, the deteriorated iron ion removal capability is regenerated, and
treatment of the hydrochloric acid and the regeneration of the iron ion removal capability are sequentially switched among the plurality of refinery columns arranged in parallel so that the production of the hydrochloric acid from the exhaust gas and the iron ion removal from the produced hydrochloric acid are continuously performed.

2. The method for producing hydrochloric acid as set forth in claim 1, wherein
the production of the hydrochloric acid by capturing the hydrogen chloride contained in the exhaust gas is performed by spraying water into a reaction tank and allowing the hydrogen chloride to be absorbed in the sprayed water.

3. The method for producing hydrochloric acid as set forth in claim 1, wherein
the removal of the iron ions from the hydrochloric acid is performed by allowing the iron ions to come into contact with and be captured by ion-exchange resins enclosed in the refinery columns.

4. The method for producing hydrochloric acid as set forth in claim 3, wherein
the ion-exchange resins are strongly basic anion-exchange resins in a form of chloro complexes that are configured to selectively capture iron ions and the iron ion removal capability of the ion-exchange resins can be restored by removing the captured iron ions from the ion-exchange resins.

5. The method for producing hydrochloric acid as set forth in claim 1, wherein
the removal of the iron ions from the hydrochloric acid is switched to the other one or some refinery columns at a time when the iron ion removal capability deteriorates in the one or some refinery columns.

6. An apparatus for producing hydrochloric acid, comprising:
a reaction tank for producing hydrochloric acid from hydrogen chloride contained in an exhaust gas resulting from a gas-phase chemical reaction process involving a dehydrochlorination reaction by spraying water to allow the hydrogen chloride to be absorbed by the sprayed water;
a plurality of refinery columns arranged in parallel, the plurality of refinery columns being configured to use ion-exchange resins to capture and remove iron ions contained in the hydrochloric acid; and
a hydrochloric acid supply line and a pure water supply line to each of the plurality of refinery columns, wherein
supplying and suspending the supply of the hydrochloric acid and pure water are sequentially switched among the plurality of refinery columns so that the iron ion removal realized by the ion-exchange resins in one or some of the refinery columns with which the hydrochloric acid is supplied and regeneration of iron ion removal capability of the ion-exchange resins realized by the pure water in another one or some of the refinery columns with which the pure water is supplied are performed in parallel.

7. The apparatus for producing hydrochloric acid as set forth in claim 6, wherein
the iron ions are continuously removed from the hydrochloric acid in such a manner that the ion-exchange resins in the plurality of refinery columns are sequentially regenerated at predetermined cycles to allow the ion-exchange resins to be used again for the iron ion removal.
